(19) United States
(12) Patent Application Publication
(10) Pub. No.: US 2022/0118657 A1
(43) Pub. Date: Apr. 21, 2022

(54) ROTOR BLADE MOLD, METHOD OF MANUFACTURING A ROTOR BLADE FOR A WIND ENERGY INSTALLATION, AND A WIND ENERGY INSTALLATION

(71) Applicant: Siemens Gamesa Renewable Energy Service GmbH, Hamburg (DE)

(72) Inventors: Enno Eyb, Kiel (DE); Hendrik Mester, Kiel (DE)

(21) Appl. No.: 17/298,260

(22) PCT Filed: Nov. 25, 2019
(86) PCT No.: PCT/EP2019/082401

§ 371 Date: May 28, 2021

(30) Foreign Application Priority Data
Nov. 28, 2018 (DE) 10 2018 009 331.0

(51) Int. Cl. B29C 33/30; F03D 1/06

(52) U.S. Cl. CPC B29C 33/301; F03D 1/0675; B29L 2031/085; F05B 2230/21; B29C 33/306

(57) ABSTRACT

A rotor blade mold and a method for manufacturing a rotor blade for a wind energy installation, wherein the rotor blade includes a blade root and a blade tip and wherein the rotor blade extends in a longitudinal direction from the blade root to the blade tip. The mold includes a first rotor blade mold segment adapted for manufacturing a portion of the rotor blade that includes the blade root, a second rotor blade mold segment adapted for manufacturing a portion of the rotor blade that includes the blade tip, and at least a third rotor blade mold segment adapted to be integrated in the rotor blade mold between the first mold segment and the second mold segment, and/or to be removed from the rotor blade mold and thereby lengthen or shorten the rotor blade mold in the longitudinal direction.

### CROSS-REFERENCE TO RELATED APPLICATIONS

This application is a national phase application under 35 U.S.C. § 371 of International Patent Application No. PCT/EP2019/082401, filed Nov. 25, 2019 (pending), which claims the benefit of priority to German Patent Application No. DE 10 2018 009 331.0, filed Nov. 28, 2018, the disclosures of which are incorporated by reference herein in their entirety.

### TECHNICAL FIELD

The present invention relates to a rotor blade mold and a method of manufacturing a rotor blade for a wind energy installation, as well as to a wind energy installation.

### BACKGROUND

Rotor blades of wind energy installations have different lengths depending on the respective site conditions in order to adapt the rotor surface of the wind energy installation to the respective site. As a rule, in the course of the manufacture of rotor blades, an individual forming tool, i. e. an individual rotor blade mold, is provided for each desired rotor blade length. The manufacture of different rotor blade molds requires long lead times and is expensive. Further, the stocking and storage of rotor blade molds of different lengths is associated with increased space requirements and corresponding costs.

### SUMMARY

It is an object of the present invention to provide a rotor blade mold and a method for the improved manufacture of a rotor blade for a wind energy installation, in particular a simpler and/or more cost-effective manufacture of a rotor blade for a wind energy installation, as well as a corresponding wind energy installation.

This object is solved by a rotor blade mold and a method of manufacturing a rotor blade as disclosed herein, as well as a wind energy installation with such rotor blades.

A rotor blade mold, in accordance with the invention, for the manufacture of a rotor blade for a wind energy installation, which rotor blade comprises a blade root and a blade tip and which extends in a longitudinal direction from the blade root to the blade tip, comprises: a first rotor blade mold segment which is adapted for the manufacture of a portion of the rotor blade which portion of the rotor blade comprises the blade root, a second rotor blade mold segment which is adapted for the manufacture of a portion of the rotor blade which portion of the rotor blade comprises the blade tip, and at least a third rotor blade mold segment which is adapted to be integrated in the rotor blade mold between the first rotor blade mold segment and the second rotor blade mold segment, and/or to be removed, from the rotor blade mold, between the first rotor blade mold segment and the second rotor blade mold segment and thereby to lengthen or shorten the rotor blade mold in the longitudinal direction.

A method, in accordance with the invention, of manufacturing a rotor blade for a wind energy installation, which rotor blade comprises a blade root and a blade tip and which extends in a longitudinal direction from the blade root to the blade tip, comprises the following steps of: providing a rotor blade mold which comprises a first rotor blade mold segment which is adapted for the manufacture of a portion of the rotor blade which portion of the rotor blade comprises the blade root, and a second rotor blade mold segment which is adapted for the manufacture of a portion of the rotor blade which portion of the rotor blade comprises the blade tip, and integrating at least a third rotor blade mold segment into the rotor blade mold between the first rotor blade mold segment and the second rotor blade mold segment, and/or removing, from the rotor blade mold, at least a third rotor blade mold segment which is located between the first rotor blade mold segment and the second rotor blade mold segment, so that the rotor blade mold is lengthened or shortened in the longitudinal direction.

A wind energy installation in accordance with the invention comprises at least one rotor blade which has been manufactured using a rotor blade mold in accordance with the invention and/or using a method in accordance with the invention.

Preferred aspects of the invention are based on the approach of providing or using, for the manufacture of a rotor blade, a rotor blade mold, which, in the context of the present invention, is also referred to as a forming tool, and which is, or can be, assembled, in dependence upon the desired length of the rotor blade, from different numbers of segments which are constructed in a modular manner. In this context, the rotor blade mold is constructed in such a way that at least one further rotor blade mold segment can be integrated into, and/or removed from, a portion of the rotor blade mold which portion is located between two outer rotor blade mold segments, in particular between a rotor blade mold segment on the blade root side and a rotor blade mold segment on the blade tip side, and/or can be exchanged for a further rotor blade mold segment, in order to increase or reduce the length of the assembled rotor blade mold in the longitudinal direction. In this context, the two outer rotor blade mold segments are constructed in such a way that the portions of the rotor blade that contain the blade root and the blade tip, respectively, are produced in them. The two outer rotor blade mold segments are therefore also referred to respectively as the blade root segment and the blade tip segment, and the further rotor blade mold segment which can be integrated, removed or exchanged is also referred to as the intermediate segment or intermediate piece.

Due to the modular construction of the segments, an adjustment of the length of the rotor blade mold can be carried out in a simple manner. If necessary, the adjustment of the length of the rotor blade mold can even be carried out in very fine steps, since—in contrast to the more complex molds of the blade root and blade tip segments—the molds of the intermediate segments which can be integrated, removed or exchanged are comparatively easy to realize. Further, with the selection of a plurality of intermediate segments, the geometry of the rotor blade mold can be approximated even better to the optimum geometry for each blade length, and the range of possible span widths can also be further increased.

Overall, an improved manufacture of rotor blades for wind energy installations, in particular a simpler and/or more cost-effective manufacture of rotor blades for wind energy installations, is made possible by means of the invention.

Preferably, rotor blade molds or forming tools in accordance with the invention are used for the manufacture of rotor blades which are each composed of two half shells, wherein a rotor blade mold of the corresponding length in accordance with the invention is preferably used for each of the two half shells.

The half shells are preferably made from a fiber composite material by placing several layers of thin textile structures, in particular textile structures which have a thickness of 1 mm to 2 mm, such as for example woven fabrics, knitted fabrics, scrim fabrics or nonwoven fabrics, into the rotor blade mold and then applying resin to these by means of a resin infusion process. As an alternative, pre-impregnated fiber layers (prepregs, as they are referred to) can be used, in which the fiber layers are already embedded in resin, in particular in a layer of resin, and in which the fiber layers form a material bond after heating and, if applicable, after the application of negative pressure. In both cases, the surface of the fiber composite material assumes a shape which corresponds to the rotor blade mold.

Preferably, the at least one third rotor blade mold segment is provided in a region or portion of the rotor blade mold that is between about 20 percent and 80 percent of a blade mold length of the rotor blade mold in the longitudinal direction. In a corresponding manner, the first rotor blade mold segment and the second rotor blade mold segment which are formed or correspondingly shaped for manufacturing the blade root and the blade tip, respectively, are preferably located in a region or portion of the rotor blade mold that is below about 20 percent and above about 80 percent, respectively, of the blade mold length of the rotor blade mold in the longitudinal direction. As a result of this, in order to enable the manufacture of rotor blades of different lengths, it is for example not necessary to store, or keep in stock, blade tip segments and/or blade root segments of different lengths, the manufacture of which is significantly more complex and thus more expensive due to the more complex shape of the rotor blade in the region of the blade tip or the blade root, respectively, than is the case with the intermediate segments, which are easier to manufacture.

In addition or as an alternative, the at least one third rotor blade mold segment has a segment length in the longitudinal direction which is not greater than 20 percent of the blade mold length of the rotor blade mold in the longitudinal direction. The portion of the mold of the rotor blade which is contained in the at least one intermediate segment can thus be realized in a particularly simple manner. Further, a length adjustment in relatively small steps is possible by means of this.

Further, it is preferred that the at least one third rotor blade mold segment is provided in a region of the rotor blade mold which is arranged for the manufacture of a substantially cylindrical region or portion of the blade root of the rotor blade. In this context, the at least one third rotor blade mold segment is preferably provided in a region or portion of the rotor blade mold which is below 20 percent, in particular below 10 percent, of the blade mold length of the rotor blade mold in the longitudinal direction. Third rotor blade mold segments which are shaped in a corresponding manner, as well as their integration, removal or exchange, can be realized particularly easily for this region.

It is further preferred that the at least one third rotor blade mold segment has a cross-sectional area extending substantially perpendicular to the longitudinal direction, the shape and/or size of which cross-sectional area is substantially constant in the longitudinal direction, i. e., at different positions of the cross-sectional area along the longitudinal direction. In this case, the at least one intermediate segment is preferably formed as a cylinder in the mathematical sense, which is in general not a circular cylinder, but preferably rather a cylinder which has a non-circular cross-sectional area. In this way, the ability of the intermediate segments to be integrated, removed or exchanged is realized in a simple manner.

Preferably, the at least one third rotor blade mold segment has each of an upper base surface and a lower base surface, wherein the upper and lower base surfaces respectively correspond, in terms of shape and/or size, to the end cross-sectional area of the end of the first and second rotor blade mold segments which respectively face towards the third rotor blade mold segment. Preferably, the base surfaces and end cross-sectional surfaces which face towards each other are congruent (identical in size and shape). For example, the lower base surface of a third rotor blade mold segment is identical in size and shape to the end cross-sectional surface of the blade root segment of the rotor blade mold which faces towards the lower base surface, and the upper base surface of the third rotor blade mold segment is identical in size and shape to the end cross-sectional surface of the blade tip segment of the rotor blade mold which faces towards the upper base surface. In this way, the ability of the third rotor blade mold segments to be integrated, removed or exchanged can be realized in a particularly simple and reliable manner.

Preferably, the at least one third rotor blade mold segment comprises a portion of a negative shape of the rotor blade shell to be manufactured.

It is also preferred that the at least one third rotor blade mold segment has each of an upper base surface and a lower base surface, wherein the upper base surface is twisted with respect to the lower base surface about a longitudinal axis running in the longitudinal direction. In contrast to an intermediate segment which is constructed in a cylindrical manner and in which the base surfaces are shifted in a parallel manner, the present intermediate segment is itself twisted, or has a torsion, along its length, i. e. the cross-sectional area of the rotor blade mold segment is twisted in the longitudinal direction. In this case, the rotor blade mold segment represents a cylinder which is twisted in the longitudinal direction. By means of this, and depending on the selected blade length, an improved distribution of the torsion can be realized.

It is further preferred that the at least one third rotor blade mold segment has each of an upper base surface and a lower base surface, wherein the upper base surface is tilted with respect to the lower base surface about at least one tilt axis which extends perpendicular to the longitudinal direction. In other words, the longitudinal axis preferably exhibits a curvature perpendicular to the profile depth such that a finite angle or a tilt is obtained between the two end cross-sections, i. e. the upper and lower base surfaces. By means of such intermediate segments, a pre-bending, as it is referred to, of the rotor blade to be manufactured can be realized. Preferably, in this case, at least a portion of the intermediate segments and/or at least one of the outer segments (i. e. the blade root segment and/or the blade tip segment, in particular the tip segment, as it is referred to (i. e. the blade tip segment), can also be adjusted about the profile chord which runs perpendicular to the longitudinal direction in the area of the joint. These adjustments can be achieved, for example, by means of an individual height adjustment at each corner of the respective intermediate segment or outer segment.

Further advantages, features and possible applications of the present invention will be apparent from the following description in connection with the figures.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows an example of a rotor blade mold in a perspective exploded view;

FIG. 2 shows an example of a rotor blade, manufactured using a rotor blade mold, in a front view; and

FIGS. 3a-3c show three examples of intermediate segments in a perspective view.

### DETAILED DESCRIPTION

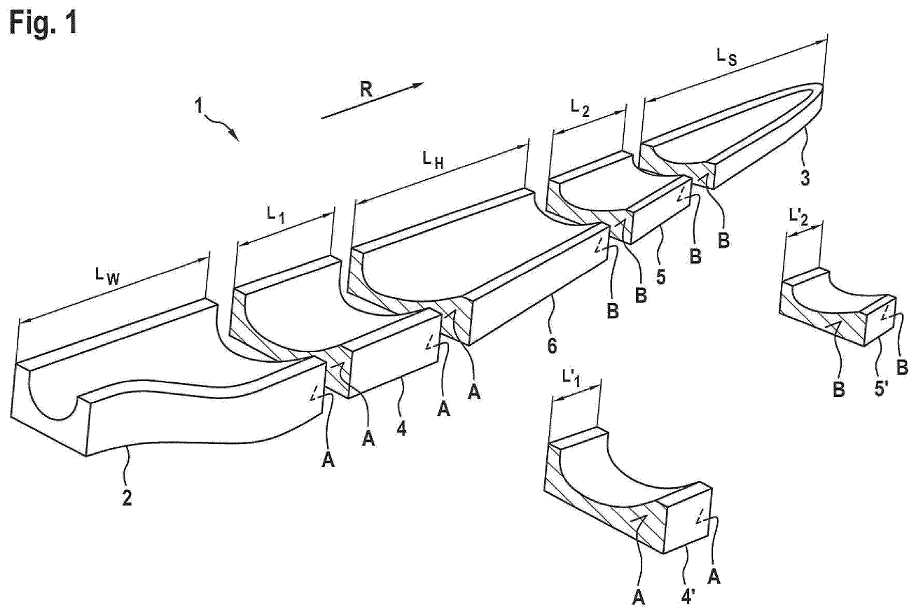

FIG. 1 shows a perspective exploded view of an example of a rotor blade mold 1 constructed as a forming tool for the manufacture of a rotor blade shell. The rotor blade mold 1 comprises a first rotor blade mold segment 2 for the manufacture of the blade root of the rotor blade and a second rotor blade segment 3 for the manufacture of the blade tip of the rotor blade.

The portion of the rotor blade mold 1 which is located between the first and the second rotor blade segment 2, 3 is in this case formed by two third rotor blade mold segments 4, 5 and a main segment 6 which is located between the third rotor blade mold segments 4, 5, wherein the two third rotor blade mold segments 4, 5 are constructed in such a way that they can be coupled or connected to the first rotor blade mold segment 2 and the main segment 6 and, respectively, to the main segment 6 and the second rotor blade mold segment 3.

In addition or as an alternative, the two third rotor blade mold segments 4, 5 are constructed in such a way that they can be, or are, releasably coupled or connected to the first and/or to the second rotor blade mold segment 2 or 3 and/or to the main segment 6, respectively, so that they can be removed from the rotor blade mold 1 formed by the segments 2 to 6, if required.

After removal of the third rotor blade mold segments 4, 5, these can be replaced respectively by further third rotor blade mold segments 4′ and 5′ which—like the rotor blade mold segments 4, 5—are constructed in such a way that they can be coupled or connected to the first rotor blade mold segment 2 and the main segment 6, or, respectively, to the main segment 6 and the second rotor blade mold segment 3. In this variant, the third rotor blade mold segments 4, 5 are thus exchanged for further third rotor blade mold segments 4′, 5′.

As an alternative, after removal of the third rotor blade mold segments 4, 5, it can however also be provided that the first and second rotor blade mold segments 2, 3 are directly connected to the main segment 6. In this context, the first and second rotor blade mold segments 2, 3 are preferably constructed in such a way that they can be coupled or connected directly, i. e. without any further intermediate segment, to the main segment 6, in particular in a releasable manner.

In the present example, in the longitudinal direction R of the rotor blade mold 1, the two third rotor blade mold segments 4, 5 each have a first segment length of L₁ and L₂, respectively, and the two further third rotor blade mold segments 4′, 5′ each have a second segment length L′₁ and L′₂, respectively, wherein the first segment lengths L₁, L₂ are greater than the second segment lengths L′₁, L′₂.

If, in the rotor blade mold 1 formed from the segments 2 to 6, the third rotor blade mold segments 4 and 5 are exchanged for the further third rotor blade mold segments 4′ and 5′ as described above, the total length of the rotor blade mold 1 is shortened by a difference in length of ΔL=(L₁−L′₁)+(L₂−L′₂).

Preferably, each of the length L_{W} of the first rotor blade mold segment 2 and/or the length L_{S} of the second rotor blade mold segment 3 is at most 20 percent of the total length L of the rotor blade mold 1. In the present example, the total length L (including the third rotor blade mold segments 4 and 5) or, respectively, L′ (including the further third rotor blade mold segments 4′ and 5′), which is also referred to as the blade mold length, is calculated from the sum of the lengths of the respective segments: L=L_{W}+L₁+L_{H}+L₂+L_{S} and L′=L_{W}+L′₁+L_{H}+L′₂+L_{S}, respectively, where L_{H} denotes the length of the main segment 6 in the longitudinal direction R.

In addition or as an alternative, the exchangeable third rotor blade mold segments 4, 4′, 5, 5′ are provided in a region of the rotor blade mold 1 which region is located between about 20 percent and 80 percent of the blade mold length L. The exchangeable third rotor blade mold segments 4, 4′, 5, 5′ themselves preferably have a segment length of L₁, L′₁, L₂ or L′₂, respectively, which is not greater than 20 percent of the blade mold length L.

It is also preferred that the respective abutting base surfaces A and B, which are also referred to as connection cross-sectional surfaces, of the rotor blade mold segments 2 to 5 and of the at least one main segment 6 are constructed in such a way that they have a substantially identical geometric shape and/or geometric shapes which correspond to one another. Because of this, the individual segments 2 to 6 can be placed against each other in a continuous manner, or removed or exchanged.

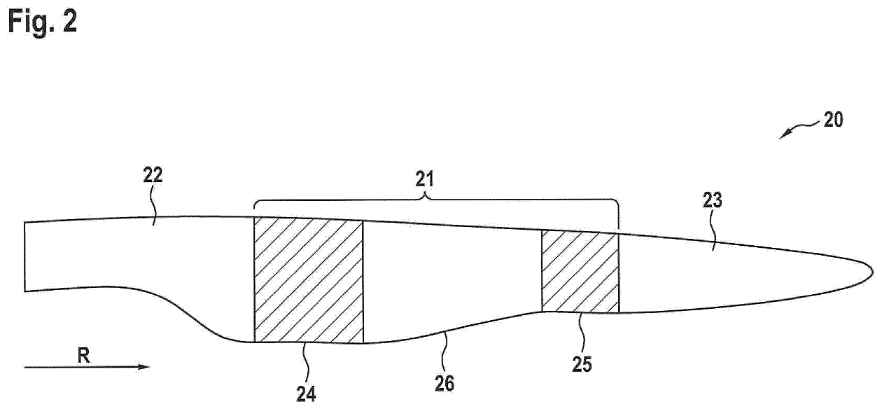

FIG. 2 shows a front view of an example of a rotor blade 20 manufactured using a rotor blade mold. The rotor blade 20 comprises a blade root 22, a blade tip 23 and a blade body 21 which is located therebetween.

In the present example, the rotor blade 20 was manufactured using the rotor blade mold 1 shown in FIG. 1, by placing, for example, several layers of thin textile structures, such as for example woven fabrics, knitted fabrics, scrim fabrics or nonwoven fabrics, into the rotor blade mold 1 and then applying resin to these by means of a resin infusion process. As an alternative, pre-impregnated fiber layers (prepregs, as they are referred to) can be used, in which the fiber layers are already embedded in resin, in particular in a layer of resin, and in which the fiber layers form a material bond after heating and, if applicable, after the application of negative pressure. In this context, the shape of the blade root 22 and of the blade tip 23 obtained in this way corresponds to the negative shape in the first and the second rotor blade mold segments 2 and 3, respectively, and the shape of the blade body 21 including its sub-portions 24 to 26 corresponds to the negative shape of the assembled third rotor blade mold segments 4, 5 and the main segment 6. By exchanging the third rotor blade mold segments 4, 5 for third rotor blade mold segments 4′, 5′ having a shorter length, the sub-portions 24 and 25 of the rotor blade 1 and thus the overall length of the rotor blade 1 become correspondingly shorter.

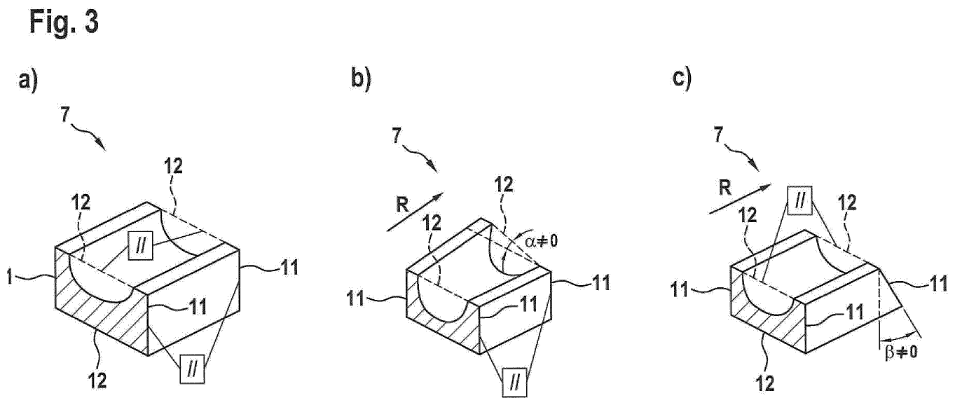

FIGS. 3a-3c show three examples of intermediate segments, i. e. third rotor blade mold segments 7, in a perspective view.

In the rotor blade mold segment 7 shown in FIG. 3 a), both the transverse edges 11 and the longitudinal edges 12 of the upper and the lower base surface (hatched) of the segment 7 are parallel to each other, which is indicated in the figure by symbols “//” which are surrounded by a little box. The upper and the lower base surfaces of the segment 7 are parallel to each other and are identical. In the present example, the rotor blade mold segment 7 has the shape of a cylinder, the base surface of which is formed by a rectangle which, in the region of one of the longitudinal edges 12, has a preferably concave curvature. The curvature extending between the upper and the lower base surface represents a portion of a negative shape of the rotor blade shell to be produced.

In the rotor blade mold segment 7 shown in FIG. 3 b), on the other hand, only the respective transverse edges 11 of the upper and the lower base surface (hatched) of the segment 7 are parallel to each other, which is indicated in the figure by a symbol “//” which is surrounded by a little box, whereas the upper and the lower base surfaces are tilted with respect to each other by an angle α>0 degrees about a first axis which runs substantially perpendicular to the longitudinal direction R of the rotor blade mold, or a first axis which runs substantially in the direction of the transverse edges 11. With third rotor blade mold segments 7 which are constructed in this way, a twist (torsion), as it is referred to, or a curvature of the rotor blade in the plane of rotation can be realized in a simple manner.

In the rotor blade mold segment 7 shown in FIG. 3 c), only the respective longitudinal edges 12 of the upper and the lower base surface (hatched) of the segment 7 are parallel to each other, which is indicated in the figure by a symbol “//” which is surrounded by a little box, whereas the two transverse edges 11 of the upper and the lower base surface are tilted with respect to each other by an angle β>0 degrees about a second axis which runs substantially perpendicular to the longitudinal direction R of the rotor blade mold, or a second axis which runs substantially in the direction of the longitudinal edges 12. With third rotor blade mold segments 7 which are constructed in this way, a pre-bending, as it is referred to, or a curvature of the rotor blade out of the plane of rotation can be realized in a simple manner.

It is also possible to tilt the upper and the lower base surface of the rotor blade mold segment 7 both as shown in FIG. 3 b) and as shown in FIG. 3 c).

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1-10. (canceled)

11. A rotor blade mold for the manufacture of a rotor blade of a wind energy installation, wherein the rotor blade comprises a blade root and a blade tip, and wherein the rotor blade extends in a longitudinal direction from the blade root to the blade tip, the rotor blade mold comprising:
a first rotor blade mold segment configured for the manufacture of a portion of the rotor blade that comprises the blade root;
a second rotor blade mold segment configured for the manufacture of a portion of the rotor blade that comprises the blade tip; and
at least a third rotor blade mold segment configured to be at least one of:
integrated in the rotor blade mold between the first rotor blade mold segment and the second rotor blade mold segment thereby to lengthen the rotor blade mold in the longitudinal direction, or
removed from the rotor blade mold from between the first rotor blade mold segment and the second rotor blade mold segment thereby to shorten the rotor blade mold in the longitudinal direction.

12. The rotor blade mold of claim 11, wherein the at least one third rotor blade mold segment is provided in a region of the rotor blade mold that is between about 20 percent and about 80 percent of a blade mold length of the rotor blade mold in the longitudinal direction.

13. The rotor blade mold of claim 11, wherein the at least one third rotor blade mold segment is provided in a region of the rotor blade mold that is configured for the manufacture of a substantially cylindrical region of the blade root of the rotor blade.

14. The rotor blade mold of claim 11, wherein the at least one third rotor blade mold segment has a segment length in the longitudinal direction which is not greater than about 20 percent of a blade mold length of the rotor blade mold in the longitudinal direction.

15. The rotor blade mold of claim 11, wherein:
the at least one third rotor blade mold segment has a cross-sectional area extending substantially perpendicular to the longitudinal direction; and
at least one of the shape or size of the cross-sectional area is substantially constant in the longitudinal direction.

16. The rotor blade mold of claim 11, wherein:
the at least one third rotor blade mold segment includes an upper base surface and a lower base surface; and
at least one of the shape or size of the cross-sectional areas of the upper and lower base surfaces correspond to the cross-sectional areas of the respective ends of the first and second rotor blade mold segments that respectively face toward the third rotor blade mold segment.

17. The rotor blade mold of claim 11, wherein:
the at least one third rotor blade mold segment includes an upper base surface and a lower base surface; and
at least one of:
the upper base surface is twisted with respect to the lower base surface about a longitudinal axis running in the longitudinal direction, or
the cross-sectional area of the at least one third rotor blade mold segment is twisted in the longitudinal direction.

18. The rotor blade mold of claim 17, wherein the at least one third rotor blade mold segment represents a cylinder that is twisted in the longitudinal direction.

19. The rotor blade mold of claim 11, wherein:
the at least one third rotor blade mold segment includes an upper base surface and a lower base surface; and
at least one of:
the upper base surface is tilted with respect to the lower base surface about at least one tilt axis that extends perpendicular to the longitudinal direction, or
a longitudinal axis of the at least one third rotor blade mold segment has a curvature perpendicular to a profile depth of the at least one third rotor blade mold segment, so that a finite angle or a tilt is obtained between the upper and lower base surfaces.

20. A method of manufacturing a rotor blade for a wind energy installation, wherein the rotor blade comprises a blade root and a blade tip, and wherein the rotor blade extends in a longitudinal direction from the blade root to the blade tip, the method comprising:
obtaining a rotor blade mold, wherein the motor blade mold comprises:
a first rotor blade mold segment configured for the manufacture of a portion of the rotor blade that comprises the blade root, and
a second rotor blade mold segment configured for the manufacture of a portion of the rotor blade that comprises the blade tip; and
at least one of:
integrating at least a third rotor blade mold segment into the rotor blade mold between the first rotor blade mold segment and the second rotor blade mold segment to thereby lengthen the rotor blade mold in the longitudinal direction, or
removing at least a third rotor blade mold segment from the rotor blade mold, from between the first rotor blade mold segment and the second rotor blade mold segment, to thereby shorten the rotor blade mold in the longitudinal direction.

21. A method of manufacturing a wind energy installation, comprising:
obtaining at least one rotor blade that has been manufactured according to the method of claim 20; and
coupling the at least one rotor blade to a hub of a wind energy installation.
